(19) United States
(12) Patent Application Publication
(10) Pub. No.: US 2025/0010812 A1
(43) Pub. Date: Jan. 9, 2025

(54) SILICONE COATINGS FOR AIRBAGS

(71) Applicants: DOW SILICONES CORPORATION, Midland, MI (US); DOW TORAY CO., LTD., Shinagawa-Ku, Tokyo (JP)

(72) Inventors: Elizabeth M. SANTOS, Midland, MI (US); Dongchan AHN, Midland, MI (US); Thomas D. BEKEMEIER, Midland, MI (US); Todd M. STARKE, Midland, MI (US); Hiroshi AKITOMO, Ichihara-City (JP); Tomoko TASAKI, Ichihara-City (JP); Glenn GORDON, Midland, MI (US)

(21) Appl. No.: 18/709,667

(22) PCT Filed: Nov. 10, 2022
(86) PCT No.: PCT/US2022/049525

§ 371 Date: May 13, 2024

Related U.S. Application Data
(60) Provisional application No. 63/279,701, filed on Nov. 16, 2021.

(51) Int. Cl. B60R 21/235; D06N 3/00; D06N 3/12

(52) U.S. Cl. CPC B60R 21/235; D06N 3/0063; D06N 3/128; B60R 2021/23514; B60R 2021/23547; D10B 2331/04; D10B 2505/124

(57) ABSTRACT

This disclosure relates to one-piece woven airbags coated with a cured product of hydrosilylation curable silicone rubber coating compositions and to a process for coating the one-piece woven airbags with the hydrosilylation curable silicone rubber coating compositions. The resulting one-piece woven airbags coated with a cured product of the hydrosilylation curable silicone rubber coating compositions are of a reduced mean dry coat weight while maintaining the properties of previous one-piece woven airbags coated with standard, thicker coatings.

This disclosure relates to one-piece woven airbags coated with a cured product of hydrosilylation curable silicone rubber coating compositions and to a process for coating said one-piece woven airbags with the hydrosilylation curable silicone rubber coating compositions. The resulting one-piece woven airbags coated with a cured product of hydrosilylation curable silicone rubber coating compositions are of a reduced mean dry coat weight whilst maintaining the properties of previous one-piece woven airbags coated with standard thicker coatings.

An airbag generally consists of a textile bag (sometimes referred to as a cushion), a sensor and a means of inflation. When the sensor detects a collision, the inflator causes an effectively immediate inflation of the airbag. In the event of an accident, a sensor within the vehicle measures abnormal deceleration and triggers an inflator. Expanding gases from the charge travel through conduits and fill the airbags, which immediately inflate in front of the driver and passenger to protect them from harmful impact with the interior of the car, typically by the release of gases. Airbags and/or airbag fabrics may be made from a woven or knitted fabric made of synthetic fibre, for example of polyamide such as nylon-6,6, or of polyester such as polyethylene terephthalate. They may be made from flat fabric pieces which are coated and then sewn together to provide sufficient mechanical strength or may be woven in one piece (generally referred to as “one-piece woven”) with integrally woven seams. Sewn flat fabric airbags are generally assembled with the coated fabric surface at the inside of the airbag. One-piece woven airbags are coated on the outside of the airbag and are better able to retain gas pressure after deployment and therefore tend to be used for airbags designed to remain inflated for longer periods of time after a collision or the like, e.g., side-curtain airbags.

A variety of airbags are utilized as inflatable safety restraint devices, designed to expand and deploy in collision situations, most notably in vehicles. Today, it is generally compulsory to have several airbags in vehicles as a means of providing safety to the occupants in the event of a collision. They include frontal airbags, front-centre airbags, side airbags, side-curtain airbags thorax airbags, and/or knee airbags. Typically, airbags are concealed within the vehicle trim to be invisible during normal vehicle operation. For example, frontal airbags may be installed in the steering wheel on the driver's side of car and in the dashboard on the passenger side of a car. They are provided to act as a cushion at a point of impact especially in collisions with the front or back of the vehicle. They exhibit relatively high air permeabilities to allow the expanded airbag to quickly deflate after the initial impact. Typically, these airbags are flat fabric pieces sewn together.

Side-curtain airbags are increasingly utilized and these are most often mounted within the headliner above the doors and windows and deploy along the side window from the vicinity of the ceiling to protect vehicle occupants from a side collision and consequent rollover incidents (where the vehicle tips over onto its side or upside-down or flips over more than once). Side-curtain airbags, however, have been designed primarily to protect passengers during rollover crashes by retaining their inflation state for a long duration (for example, exhibiting a retention of at least 50% of the initial pressure after 5 seconds subsequent to high pressure inflation) and generally unroll from packing containers stored within the roofline along the side windows of an automobile (and thus have a back and front side only). Side-curtain airbags therefore not only provide cushioning effects but also provide protection from broken glass and other debris. As such, it is imperative that side-curtain airbags, as noted above, remain inflated for several seconds until the end of the rollover period resulting from the collision, i.e., they need to retain large amounts of gas, as well as high gas pressures, throughout the longer time periods of the entire potential rollover. Side-curtain airbag fabrics which comprise woven blanks that are sewn or sealed, suffer from potentially high leakage of gas, particularly at and around the seams and as such to accomplish this, they are coated with very large amounts of silicone sealing materials.

One-piece woven type airbags do not tend to suffer from the same degree of leakage as flat fabric sewn airbags and therefore are now usually used for side-curtain airbags in combination with silicone sealant coatings in order to provide the low permeability (and thus longer gas escape times) necessary for side-curtain airbags. The use of one-piece woven (OPW) type airbags enable complex side-curtain airbag structures with woven seams to be manufactured with great flexibility in creating patterns and designs. For example, side-curtain airbags, activated by a lateral collision, are shaped according to the interior contours of the particular car they are fitted in. The method of manufacture of such airbags as well as their shape and structure are created at the weaving stage. As a result, no subsequent sewing operation is required. To effectively protect passengers in a rollover situation, OPW side-curtain airbags must remain inflated for several seconds. However even one-piece woven (OPW) type airbags generally require a silicone coating having a mean dry coat weight of greater than or equal (≥) to 65 g/m² for this to be achieved.

The silicone coatings are not only designed to prevent air leakage but are also designed to keep the airbags flexible and resistant to temperature fluctuations, aging and abrasion. They need such properties because, for example, an airbag may remain unused for a long period of time before a collision triggers deployment. This requires the silicone coating to be very stable over time in order to prevent the airbag from becoming stuck and to ensure smooth deployment even after many years. Furthermore, they need good thermal stability given the inflator is usually designed to release extremely hot gases during inflation which could otherwise cause burns to the passenger and prevents, or at least significantly reduces, the likelihood of the fabric onto which the coating is coated from burning through to the passenger. Unfortunately, silicone airbag coatings have proven ineffective at low add-on coating weights i.e., below the aforesaid 65 g/m² over target airbag fabric surfaces for low permeability characteristics. Furthermore, whilst traditionally utilized silicone airbag coatings provide excellent durability, aging, and processability benefits, they also tend to display very low tensile strength and elongation at break characteristics that do not withstand high pressure inflation easily without the utilization of very thick coatings.

Also using one-piece woven airbags has eliminated the possibility of coating on both the front and back sides of individual fabric panels. As such, there is a greater need to accord relatively thin coating layers on solely the outside panels (i. e., front) of such articles and this has led the industry to understand that without such heavy coatings, airbags would most likely deflate too quickly and thus would not function properly during a rollover collision. These heavy coatings add great cost to the overall manufacture of airbags. However, when the coating amount of a curable silicone rubber composition applied to a woven fabric is reduced for the purpose of reduction of the weight of a curtain airbag and cost, using a conventional known curable silicone rubber composition for coating woven fabrics, there is a problem in that the inflation duration of the airbag is excessively shortened. There therefore is a need to manufacture one-piece woven airbags using silicone airbag coatings with less expensive (i.e. lower mean dry coat weight) silicone airbag coatings without losing the aging, humidity, and permeability characteristics necessary for proper functioning upon deployment to allow for an overall lower total cost of ownership for manufacturers, due to the reduction in the amount of silicone coating needed, whilst having the ability to sustain a sufficiently long inflation time, similar to the incumbent material, to allow the airbag to protect the occupants throughout the duration of impact.

There is provided herein a one-piece woven airbag comprising a coating having a mean dry coat weight of from 45 to 62 g/m², tested in accordance with ISO 3801 which coating is the cured elastomeric product of a hydrosilylation curable silicone coating composition comprising:
a) an organopolysiloxane polymer having a viscosity of between 100 and 200,000 mPa·s inclusive at 25° C., and at least two unsaturated groups per molecule, which unsaturated groups are selected from alkenyl or alkynyl groups;
b) reinforcing fillers comprising fumed silica, precipitated silica and/or calcium carbonate;
c) an organosilicon compound having at least two, alternatively at least three Si—H groups per molecule;
d) a hydrosilylation cure catalyst;
e) one or more substantially non-functional organosilicon compounds selected from
   (i) silicone resins selected from T silicone resins (silsesquioxanes), DT silicone resins, MQ silicone resins, MDT silicone resins, MTQ silicone resins, QDT silicone resins or mixtures thereof and/or
   (ii) a trialkyl terminated polydiorganosiloxane;
f) an adhesion promoter selected from one or more monoacrylates, diacrylates or methacrylates;
epoxy-containing alkoxysilanes, alkoxysilane containing methacrylic groups or acrylic groups and a mixture and/or reaction product of
   i) one or more alkoxysilanes having an epoxy group in the molecule;
   ii) a linear organopolysiloxane oligomer containing at least one alkenyl group and at least one hydroxy or alkoxy group per molecule; and
   iii) an organometallic condensation reaction catalyst comprising organoaluminum or organozirconium compounds; or a mixture thereof;
      said coating having a loss tangent (tan δ) value of at least 0.175 at an angular frequency of 500 rad/s where

tan δ=G″/G′=dynamic loss modulus/dynamic storage modulus

is determined by the rheological test method disclosed in the description.

There is also provided a method of preparing a coated one-piece woven airbag as hereinbefore described by mixing the components of a hydrosilylation curable silicone coating composition comprising:
a) an organopolysiloxane polymer having a viscosity of between 100 and 200,000 mPa·s inclusive at 25° C., and at least two unsaturated groups per molecule, which unsaturated groups are selected from alkenyl or alkynyl groups;
b) reinforcing fillers comprising fumed silica and/or precipitated silica;
c) an organosilicon compound having at least two, alternatively at least three Si—H groups per molecule;
d) a hydrosilylation cure catalyst;
e) one or more substantially non-functional organosilicon compounds selected from
   (i) silicone resins selected from T silicone resins (silsesquioxanes), DT silicone resins, MQ silicone resins, MDT silicone resins, MTQ silicone resins, QDT silicone resins or mixtures thereof and/or
   (ii) a trialkyl terminated polydiorganosiloxane;
f) an adhesion promoter selected from one or more monoacrylates, diacrylates or methacrylates;
epoxy-containing alkoxysilanes, alkoxysilane containing methacrylic groups or acrylic groups and a mixture and/or reaction product of
   i) one or more alkoxysilanes having an epoxy group in the molecule;
   ii) a linear organopolysiloxane oligomer containing at least one alkenyl group and at least one hydroxy or alkoxy group per molecule; and
   iii) an organometallic condensation reaction catalyst comprising organoaluminum or organozirconium compounds; or a mixture thereof; and
      coating the one-piece woven airbag such that upon cure said one-piece woven airbag has a mean dry coat weight of from 45 to 62 g/m² determined in accordance with ISO 3801, and wherein said coating having a loss tangent (tan δ) value of at least 0.175 at an angular frequency of 500 rad/s where

tan δ=G″/G′=dynamic loss modulus/dynamic storage modulus

as determined by the rheological test method disclosed in the examples herein.

Preferably in each instance above said one-piece woven airbag, when coated also has greater than 60% inner pressure-holding properties retained after 6 seconds from deployment determined using a cold gas inflation system commercially available from Microsys Technologies Inc. which is capable of holding in reserve a predetermined volume of gas or blend of gases to which an airbag is fixed. Upon test initiation via the retained pressure is released from a holding reservoir into the bag. The highest-pressure response measured after the pressure release is considered the ‘peak’ pressure that is achieved in the airbag. The difference in pressure observed from test initiation (P_{Osec}) to a target test duration is commonly referred to as ‘pressure retention’ with the standard test duration of 6 seconds (P_{6 sec}) being used.

The one-piece woven airbags coated as hereinbefore described with the cured product of the hydrosilylation curable silicone coating composition described herein is capable of sustaining a long inflation time for the inflated one-piece woven airbag even when the coating amount of the composition applied to a woven fabric is reduced for the purpose of weight and cost reduction in a one-piece woven airbag with the having a mean dry coat weight of from 45 to 62 g/m², alternatively from 50 to 62 g/m² determined in accordance with ISO 3801. Further, a one-piece woven airbag coated with the cured product of the liquid curable silicone rubber composition is excellent for producing curtain airbags. The fact that the loss tangent (tan δ) value of the cured product of said composition is greater than that of a non-component (e) filled analog suggests it is more robust and as such this can reduce the amount of damage incurred upon deployment of the airbag.

The composition utilized to make the coating comprises the following components:

Component (a) of the hydrosilylation curable silicone coating composition is one or more organopolysiloxane polymers having a viscosity of between 100 and 200,000 mPa·s inclusive at 25° C., and at least two unsaturated groups per molecule, which unsaturated groups are selected from alkenyl or alkynyl groups. Each organopolysiloxane polymer of component (a) comprises multiple siloxy units, of formula (I):

R′ₐSiO_{(4-a)/2} (I)

The subscript “a” is 0, 1, 2 or 3.

Siloxy units may be described by a shorthand (abbreviated) nomenclature, namely—“M,” “D,” “T,” and “Q”, when R′ is as described above, alternatively an alkyl group, typically a methyl group. The M unit corresponds to a siloxy unit where a=3, that is R′₃SiO₁₂; the D unit corresponds to a siloxy unit where a=2, namely R′₂SiO_{2/2}; the T unit corresponds to a siloxy unit where a=1, namely R′₁SiO_{2/2}; the Q unit corresponds to a siloxy unit where a=0, namely SiO_{4/2}. The organopolysiloxane polymer of component (a) is substantially linear but may contain a proportion of branching due to the presence of T units (as previously described) within the molecule, hence the average value of a in structure (I) is about 2.

The unsaturated groups of component (a) may be positioned either terminally or pendently on the organopolysiloxane polymer, or in both locations. The unsaturated groups of component (a) may be alkenyl groups or alkynyl groups as described above. Each alkenyl group, when present, may comprise for example from 2 to 30, alternatively 2 to 24, alternatively 2 to 20, alternatively 2 to 12, alternatively 2 to 10, and alternatively 2 to 6 carbon atoms. When present the alkenyl groups may be exemplified by, but not limited to, vinyl, allyl, methallyl, propenyl, and bexenyl and cyclohexenyl groups. Each alkynyl group, when present, may also have 2 to 30, alternatively 2 to 24, alternatively 2 to 20, alternatively 2 to 12, alternatively 2 to 10, and alternatively 2 to 6 carbon atoms. Examples of alkynyl groups may be exemplified by, but not limited to, ethynyl, propynyl, and butynyl groups. Preferred examples of the unsaturated groups of component (a) include vinyl, propenyl, isopropenyl, butenyl, allyl, and 5-hexenyl.

In formula (I), each R′, other than the unsaturated groups described above, is independently selected from an aliphatic hydrocarbyl group, a substituted aliphatic hydrocarbyl group, an aromatic group or a substituted aromatic group. Each aliphatic hydrocarbyl group may be exemplified by, but not limited to, alkyl groups having from 1 to 20 carbons per group, alternatively 1 to 15 carbons per group, alternatively 1 to 12 carbons per group, alternatively 1 to 10 carbons per group, alternatively 1 to 6 carbons per group or cycloalkyl groups such as cyclohexyl. Specific examples of alkyl groups may include methyl, ethyl, propyl, pentyl, octyl, undecyl, and octadecyl groups, alternatively methyl and ethyl groups. Substituted aliphatic hydrocarbyl group are preferably non-halogenated substituted alkyl groups.

The aliphatic non-halogenated organyl groups are exemplified by, but not limited to alkyl groups as described above with a substituted group such as suitable nitrogen containing groups such as amido groups, imido groups; oxygen containing groups such as polyoxyalkylene groups, carbonyl groups, alkoxy groups and hydroxyl groups. Further organyl groups may include sulfur containing groups, phosphorus containing groups, boron containing groups. Examples of aromatic groups or substituted aromatic groups are phenyl groups and substituted phenyl groups with substituted groups as described above.

Component (a) may, for example, be selected from polydimethylsiloxanes, alkylmethylpolysiloxanes, alkylarylpolysiloxanes or copolymers thereof (where reference to alkyl means any suitable alkyl group, alternatively an alkyl group having two or more carbons) providing each polymer has a viscosity of organopolysiloxane polymer (a) should be between 100 and 200,000 mPa·s inclusive at 25° C., Hence component (a) may, for the sake of example, be:
a dialkylalkenyl terminated polydimethylsiloxane, e.g. dimethylvinyl terminated polydimethylsiloxane; a dialkylalkenyl terminated dimethylmethylphenylsiloxane, e.g. dimethylvinyl terminated dimethylmethylphenylsiloxane; a trialkyl terminated dimethylmethylvinyl polysiloxane; a dialkylvinyl terminated dimethylmethylvinyl polysiloxane copolymer; a dialkylvinyl terminated methylphenylpolysiloxane, a dialkylalkenyl terminated methylvinylmethylphenylsiloxane; a dialkylalkenyl terminated methylvinyldiphenylsiloxane; a dialkylalkenyl terminated methylvinyl methylphenyl dimethylsiloxane; a trimethyl terminated methylvinyl methylphenylsiloxane; a trimethyl terminated methylvinyl diphenylsiloxane; or a trimethyl terminated methylvinyl methylphenyl dimethylsiloxane.

In each case component (a) The viscosity of organopolysiloxane polymer (a) should be between 100 and 200,000 mPa·s inclusive at 25° C., alternatively from 1000 to 150,000 mPa·s at 25° C., alternatively, from 1000 mPa·s to 125,000 mPa·s, alternatively from 1000 mPa·s to 70,000 mPa·s at 25° C. Unless otherwise indicated all viscosity measurement given are zero-shear viscosity (ηₒ) values, obtained by extrapolating to zero the value taken at low shear rates (or simply taking an average of values) in the limit where the viscosity-shear rate curve is rate-independent, which is a test-method independent value provided a suitable, properly operating rheometer is used. For example, the zero-shear viscosity of a substance at 25° C. may be obtained by using commercial rheometers such as an Anton-Parr MCR-301 rheometer or a TA Instruments AR-2000 rheometer equipped with cone-and-plate fixtures of suitable diameter to generate adequate torque signal at a series of low shear rates, such as 0.01 s⁻¹, 0.1 s⁻¹ and 1.0 s⁻¹ while not exceeding the torque limits of the transducer. Alternatively, the viscosity measurements may be obtained using an ARES-G2 rotational rheometer, commercially available from TA Instruments using a steady rate sweep from 0.1 to 10 s⁻¹ on a 25 mm cone and plate. If the zero-shear plateau region cannot be observed at shear rates accessible to the rheometer or viscometer, we report the viscosity measured at a standard shear rate of 0.1 s⁻¹ at 25° C.

Typically, the alkenyl and/or alkynyl content, e.g. vinyl content of the polymer is from 0.01 to 3 wt. % for each organopolysiloxane polymer containing at least two silicon-bonded alkenyl groups per molecule of component (a), alternatively from 0.01 to 2.5 wt. % of component (a), alternatively from 0.001 to 2.0 wt. %, alternatively from 0.01 to 1.5 wt. % of component (a) of the or each organopolysiloxane polymer containing at least two unsaturated groups per molecule, which unsaturated groups are selected from alkenyl or alkynyl groups per molecule of component (a). The alkenyl/alkynyl content of component (a) is determined using quantitative infra-red analysis in accordance with ASTM E168.

Component (a) may be present in the composition in an amount of from 40 wt. % to about 80 wt. % of the composition, alternatively from 45 to 80 wt. % of the composition, alternatively from 50 to 80 wt. % of the composition. Typically, component (a) is present in an amount which is the difference between 100 wt. % and the cumulative wt. % of the other components/ingredients of the composition.

### Component (b)

Component (b) of the hydrosilylation curable silicone coating composition is a reinforcing filler comprising fumed silica and/or precipitated silica. Finely divided forms of silica are preferred. Reinforcing fillers (b) e.g., silica fillers having a relatively high surface area, typically at least 50 m²/g (BET method in accordance with ISO 9277: 2010) are utilized. For example, fillers, (e.g., fumed silica) having surface areas of from 50-450 m²/g, alternatively, 50-400 m²/g m²/g, alternatively from 50 to 300 m²/g, alternatively 100-300 m²/g (BET method in accordance with ISO 9277: 2010) are typically used.

Typically, the reinforcing filler(s) (b) is/are naturally hydrophilic (e.g., untreated) silica fillers, and are therefore treated with a treating agent to render it/them hydrophobic. These surface modified reinforcing fillers (b) do not clump and can be homogeneously incorporated into organopolysiloxane polymer (a), described below, as the surface treatment makes the fillers easily wetted by organopolysiloxane polymer (a).

Typically, reinforcing filler (b) may be surface treated with any low molecular weight organosilicon compounds disclosed in the art applicable to prevent creping of organosiloxane compositions during processing. For example, organosilanes, polydiorganosiloxanes, or organosilazanes e.g., hexaalkyl disilazane, short chain siloxane diols or fatty acids or fatty acid esters such as stearates may be used to render the filler(s) hydrophobic and therefore easier to handle and obtain a homogeneous mixture with the other ingredients. Specific examples include but are not restricted to silanol terminated trifluoropropylmethyl siloxane, silanol terminated vinylmethylsiloxane, tetramethyldi(trifluoropropyl)disilazane, tetramethyldivinyl disilazane, silanol terminated MePh siloxane, liquid hydroxyl-terminated polydiorganosiloxane containing an average from 2 to 20 repeating units of diorganosiloxane in each molecule, hexaorganodisiloxane, hexaorganodisilazane. A small amount of water can be added together with the silica treating agent(s) as a processing aid. The reinforcing silica fillers (b) may be pre-treated prior to introduction into the hydrosilylation curable silicone coating composition or may be treated in situ (i.e., in the presence of at least a portion of the other ingredients of the hydrosilylation curable silicone coating composition herein by blending these ingredients together at room temperature or above until the filler is completely treated. Typically, untreated reinforcing filler (b) is treated in situ with a treating agent in the presence of organopolysiloxane polymer (a) which results in the preparation of a silicone rubber base material which can subsequently be mixed with other ingredients.

Reinforcing filler (b) is present in the composition in an amount of from 1.0 to 50 wt. %. of the composition, alternatively of from 1 to 30 wt. %. of the composition, alternatively of from 5.0 to 25 wt. %. of the composition.

### Component (c)

Component (c) functions as a cross-linker and is provided in the form of an organosilicon compound having at least two, alternatively at least three Si—H groups per molecule. Component (c) normally contains three or more silicon-bonded hydrogen atoms so that the hydrogen atoms can react with the unsaturated groups (alkenyl and/or alkynyl groups) of component (a) and/or the rest of the composition to form a network structure therewith and thereby cure the composition. Some or all of Component (c) may alternatively have two silicon bonded hydrogen atoms per molecule. However, such a molecule is only used as the sole cross-linker when e.g., polymer (a) has greater than two unsaturated groups per molecule in which case a network can be produced during the cure process. Otherwise, when component (c) partially comprises molecules having two silicon bonded hydrogen atoms per molecule, said molecules may function as a chain extender.

The molecular configuration of the organosilicon compound having at least two, alternatively at least three Si—H groups per molecule (c) is not specifically restricted, and it can be a silane or a straight chain, branched (a straight chain with some branching through the presence of T units) or cyclic polymer or be silicone resin based.

While the molecular weight of component (c) is not specifically restricted, the viscosity may be measured in any suitable way and is identified in terms of zero-shear viscosity (ηₒ) values using the methodology discussed above.

Silicon-bonded organic groups used in component (c) may be exemplified by alkyl groups such as methyl, ethyl, propyl, n-butyl, t-butyl, pentyl, hexyl; aryl groups such as phenyl tolyl, xylyl, or similar aryl groups; 3-chloropropyl, 3,3,3-trifluoropropyl, or similar halogenated alkyl group, preferred alkyl groups having from 1 to 6 carbons, especially methyl ethyl or propyl groups or phenyl groups. Preferably the silicon-bonded organic groups used in component (c) are alkyl groups, alternatively methyl, ethyl or propyl groups.

Examples of the organosilicon compound having at least two, alternatively at least three Si—H groups per molecule (c) include but are not limited to:
(a) trimethylsiloxy-terminated methylhydrogenpolysiloxane,
(b) trimethylsiloxy-terminated polydimethylsiloxane-methylhydrogensiloxane,
(c) dimethylhydrogensiloxy-terminated dimethylsiloxane-methylhydrogensiloxane copolymers,
(d) dimethylsiloxane-methylhydrogensiloxane cyclic copolymers,
(e) copolymers and/or silicon resins consisting of (CH₃)₂HSiO_{1/2} units, (CH₃)₃SiO_{1/2} units and SiO_{4/2} units,
(f) copolymers and/or silicone resins consisting of (CH₃)₂HSiO_{1/2} units and SiO_{4/2} units, (g) Methylhydrogensiloxane cyclic homopolymers having between 3 and 10 silicon atoms per molecule;
alternatively, component (c), the cross-linker, may be a filler, e.g., silica treated with one of the above, and mixtures thereof.

In one embodiment the Component (c) is selected from a methylhydrogenpolysiloxane capped at both molecular terminals with trimethylsiloxy groups; a copolymer of a methylhydrogensiloxane and a dimethylsiloxane capped at both molecular terminals with trimethylsiloxy groups; dimethylsiloxane capped at both molecular terminals with dimethylhydrogensiloxy groups; a copolymer of a methylhydrogensiloxane and a dimethylsiloxane capped at both molecular terminals with dimethylhydrogensiloxy groups.

The cross-linker (c) is generally present in the hydrosilylation curable silicone coating composition such that the molar ratio of the silicon-bonded hydrogen atoms in component (c) to the total unsaturated groups selected from alkenyl and/or alkynyl groups in the composition is from 0.5:1 to 20:1. When this ratio is less than 0.5:1, a well-cured composition will not be obtained. When the ratio exceeds 20:1, there is a tendency for the hardness of the cured composition to increase when heated.

The molar ratio of silicon-bonded hydrogen atoms of component (c) to total unsaturated groups selected from alkenyl and/or alkynyl groups in the organopolysiloxane (a) is preferably at least 1:1 and can be up to 8:1 or 10:1. Most preferably the molar ratio of Si—H groups to aliphatically unsaturated groups is in the range from 1.1:1 to 5:1.

The silicon-bonded hydrogen (Si—H) content of component (c) is determined using quantitative infra-red analysis in accordance with ASTM E168. In the present instance the silicon-bonded hydrogen to alkenyl (vinyl) and/or alkynyl ratio is important when relying on a hydrosilylation cure process. Generally, this is determined by calculating the total weight % of alkenyl groups in the composition, e.g., vinyl [V] and the total weight % of silicon bonded hydrogen [H] in the composition and given the molecular weight of hydrogen is 1 and of vinyl is 27 the molar ratio of silicon bonded hydrogen to vinyl is 27[H]/[V].

Typically, dependent on the number of unsaturated groups in component (a) and the rest of the composition as well as the number of Si—H groups in component (c), component (c) will be present in an amount of from 0.1 to 10 wt. % of the hydrosilylation curable silicone coating composition, alternatively 0.1 to 7.5 wt. % of the hydrosilylation curable silicone coating composition, alternatively 0.25 to 7.5 wt. %, further alternatively from 0.25% to 5 wt. % of the hydrosilylation curable silicone coating composition, alternatively from 0.25% to 5 wt. % of the hydrosilylation curable silicone coating composition.

### (d) Hydrosilylation Catalyst

Component (d) of the hydrosilylation curable silicone coating composition, is a hydrosilylation catalyst comprising or consisting of a platinum group metal or a compound thereof. These are usually selected from catalysts of the platinum group of metals (platinum, ruthenium, osmium, rhodium, iridium and palladium), or a compound of one or more of such metals. Alternatively, platinum and rhodium compounds are preferred due to the high activity level of these catalysts in hydrosilylation reactions, with platinum compounds most preferred. In a hydrosilylation (or addition) reaction, a hydrosilylation catalyst such as component (d) herein catalyses the reaction between an unsaturated group, usually an alkenyl group e.g., vinyl with Si—H groups.

The hydrosilylation catalyst of component (d) can be a platinum group metal, a platinum group metal deposited on a carrier, such as activated carbon, metal oxides, such as aluminum oxide or silicon dioxide, silica gel or powdered charcoal, or a compound or complex of a platinum group metal. Preferably the platinum group metal is platinum.

Examples of preferred hydrosilylation catalysts of component (d) are platinum based catalysts, for example, platinum black, platinum oxide (Adams catalyst), platinum on various solid supports, chloroplatinic acids, e.g. hexachloroplatinic acid (Pt oxidation state IV) (Speier catalyst), chloroplatinic acid in solutions of alcohols e.g. isooctanol or amyl alcohol (Lamoreaux catalyst), and complexes of chloroplatinic acid with ethylenically unsaturated compounds such as olefins and organosiloxanes containing ethylenically unsaturated silicon-bonded hydrocarbon groups, e.g. tetra-vinyl-tetramethylcyclotetrasiloxane-platinum complex (Ashby catalyst). Soluble platinum compounds that can be used include, for example, the platinum-olefin complexes of the formulae (PtCl₂·(olefin)₂ and H(PtCl₃·olefin), preference being given in this context to the use of alkenes having 2 to 8 carbon atoms, such as ethylene, propylene, isomers of butene and of octene, or cycloalkanes having 5 to 7 carbon atoms, such as cyclopentene, cyclohexene, and cycloheptene. Other soluble platinum catalysts are, for the sake of example a platinum-cyclopropane complex of the formula (PtCl₂C₃H₆)₂, the reaction products of hexachloroplatinic acid with alcohols, ethers, and aldehydes or mixtures thereof, or the reaction product of hexachloroplatinic acid and/or its conversion products with vinyl-containing siloxanes such as methylvinylcyclotetrasiloxane in the presence of sodium bicarbonate in ethanolic solution. Platinum catalysts with phosphorus, sulfur, and amine ligands can be used as well, e.g. (Ph₃P)₂PtCl₂; and complexes of platinum with vinylsiloxanes, such as sym-divinyltetramethyldisiloxane (Karstedt's catalyst).

Hence, specific examples of suitable platinum-based catalysts of component (d) include (i) complexes of chloroplatinic acid with organosiloxanes containing ethylenically unsaturated hydrocarbon groups are described in U.S. Pat. No. 3,419,593;
(ii) chloroplatinic acid, either in hexahydrate form or anhydrous form;
(iii) a platinum-containing catalyst which is obtained by a method comprising reacting chloroplatinic acid with an aliphatically unsaturated organosilicon compound, such as divinyltetramethyldisiloxane;
(iv) alkene-platinum-silyl complexes as described in U.S. Pat. No. 6,605,734 such as (COD)Pt(SiMeCl₂)₂ where “COD” is 1,5-cyclooctadiene; and/or
(v) Karstedt's catalyst, a platinum divinyl tetramethyl disiloxane complex typically containing about 1 wt. % of platinum typically in a vinyl siloxane polymer. Solvents such as toluene and the like organic solvents have been used historically as alternatives but the use of vinyl siloxane polymers by far the preferred choice. These are described in U.S. Pat. Nos. 3,715,334 and 3,814,730. In one preferred embodiment component (d) may be selected from co-ordination compounds of platinum. In one embodiment hexachloroplatinic acid and its conversion products with vinyl-containing siloxanes, Karstedt's catalysts and Speier catalysts are preferred.

The catalytic amount of the hydrosilylation catalyst is generally between 0.01 ppm, and 10,000 parts by weight of platinum-group metal, per million parts (ppm), based on the weight of the composition; alternatively, between 0.01 and 5000 ppm; alternatively, between 0.01 and 3,000 ppm, and alternatively between 0.01 and 1,000 ppm. In specific embodiments, the catalytic amount of the catalyst may range from 0.01 to 1,000 ppm, alternatively 0.01 to 750 ppm, alternatively 0.01 to 500 ppm and alternatively 0.01 to 100 ppm of metal based on the weight of the composition. The ranges may relate solely to the metal content within the catalyst or to the catalyst altogether (including its ligands) as specified, but typically these ranges relate solely to the metal content within the catalyst. The catalyst may be added as a single species or as a mixture of two or more different species. Typically, dependent on the form/concentration in which the catalyst is provided e.g., in a polymer or solvent, the amount of component (d) present will be within the range of from 0.001 to 3.0 wt. % of the composition, alternatively from 0.001 to 1.5 wt. % of the composition, alternatively from 0.01-1.5 wt. %, alternatively 0.01 to 0.1.0 wt. %, of the hydrosilylation curable silicone coating composition.

### (e) One or More Substantially Non-Functional Organosilicon Compounds

The one or more substantially non-functional organosilicon compounds of component (e) in the hydrosilylation curable silicone coating composition are selected from
(i) silicone resins selected from T silicone resins (silsesquioxanes), DT silicone resins, MQ silicone resins, MDT silicone resins, MTQ silicone resins, QDT silicone resins or mixtures thereof and/or
(ii) a trialkyl terminated polydiorganosiloxane.

Such resins of component (e) (i) using the MDTQ notation comprise Q type (SiO_{4/2}) siloxane units T type (R²₁SiO_{3/2}) siloxane units; D type (R²₁SiO_{3/2}) siloxane units and R²₃SiO_{1/2} (M) siloxane units as indicated. These resins can be classified into two broad categories: silsesquioxanes and silicates. Silsesquioxanes, or T resins, are predominantly comprised of T units and can be synthesized by the hydrolysis and condensation of alkoxysilanes, chlorosilanes, or mixtures thereof. Silicates, or MQ resins, are predominantly comprised of M and Q units and can be synthesized through the hydrolysis and condensation of alkoxysilanes and chlorosilanes. Alternatively, MQ resins can be synthesized through the polymerization of aqueous alkali silicates in the presence of acid followed by reaction with triorgano alkoxysilanes, triorgano chlorosilanes, hexaorganodisiloxanes or mixtures thereof. Typically, MQ resins of component (e) (i) comprise SiO_{4/2} (Q) siloxane units and R²₃SiO_{1/2} (M) siloxane units wherein each R² may be the same or different and denotes a monovalent group selected from hydrocarbon groups, having from 1 to 20 carbon atoms and, alternatively from 1 to 12 carbon atoms. Examples of suitable R² groups include alkyl groups, such as methyl, ethyl, propyl, pentyl, octyl, undecyl and octadecyl; cycloaliphatic groups, such as cyclohexyl; aryl groups such as phenyl, tolyl, xylyl, benzyl, alpha-methyl styryl and 2-phenylethyl; alternatively R² groups are methyl, ethyl or phenyl groups, e.g. examples of preferred unreactive R²₃SiO_{1/2} (M) siloxane units include Me₃SiO_{1/2}, PhMe₂SiO_{1/2} and Ph₂MeSiO_{1/2}, where Me hereinafter denotes methyl and Ph hereinafter denotes phenyl. T silicone resins may alternatively be referred to as silsesquioxanes. The silicone resin can be a single silicone resin or a mixture comprising two or more different silicone resins, each as described above.

As previously identified the silicone resin(s) of (e) (i) are substantially non-functional. By substantially non-functional we mean that the silicone resin(s) of (e) (i) do not have chemical available groups which can be chemically involved in the cure process. Hence in particular, the substantially non-functional silicone resin(s) of (e) (i) are free of silicon bonded hydrogen groups and silicon bonded alkenyl groups. In a most preferred embodiment, the resin(s) of (e) (i) contain less than 0.035 moles hydroxyl per mole Si and are free of silicon bonded hydrogen groups and silicon bonded alkenyl groups. This may be checked by infra-red analysis in accordance with ASTM E168. The silicone resin(s) of (e) (i) will also contain less than 0.06 moles hydroxyl per mole of silicon (Si), alternatively less than 0.05 moles hydroxyl per mole of Si, alternatively less than 0.04 moles hydroxyl per mole of Si, alternatively less than 0.035 moles hydroxyl per mole of Si as quantified by ²⁹Si NMR. Any remaining silanol, while present, will be sterically inaccessible and will not participate in any subsequent reaction such that resin will be unable to covalently link to the other components in the formulation or to the substrate surface.

The non-functional silicone resin of (e) (i) is predominantly comprised of R²₃SiO_{1/2} (M) siloxane units and SiO_{4/2} (Q) units. Additionally, the silicone resin may contain residual OZ, where OZ can represent hydrogen or alkyl groups. OZ remain on the Q components after synthesis of silicone MQ resins indicative of incomplete condensation during the reaction to produce the MQ resin providing the OZ content meets the above hydroxyl per mole Si requirements. Residual OZ is inherent to the processes and reactions utilized to make MQ resins. The non-functional silicone MQ resin may also undergo a subsequent silylation reaction to further minimize residual OZ.

The silicone resin (e) (i) is typically delivered in a hydrocarbon or silicone solvent, free from solvent the silicone resin is typically a solid but preferably herein the silicone resin (e) (i) is delivered in a silicone solvent such as a non-functional polydimethylsiloxane e.g., component (e) (ii) or a polydimethylsiloxane comprising two or more alkenyl groups per molecule, such as for example component (a) herein.

For example, any suitable MQ resin may be utilized as component (e) (i). The molar ratio of M siloxane units to Q siloxane units has a value of from 0.5:1 to 1.2:1, alternatively 0.6:1 to 1.1:1, alternatively 0.8:1 to 1.1:1, alternatively 0.9:1 to 1.1:1. In one embodiment MQ resin (e) (i) includes a resinous portion wherein the M units are bonded to SiO₄ siloxane units (i.e., Q units) and each of Q units is bonded to at least one other SiO₄ siloxane unit. The molar ratio of M units to Q units is from 0.5:1 to 1.2:1, alternatively 0.6:1 to 1.1:1, alternatively 0.8:1 to 1.1:1, alternatively 0.9:1 to 1.1:1. Such an MQ resin suitable as component (e) (i) may have a number-average molecular weight (Mn) of from 2000 to 50,000 g/mol, alternatively from 3,000 to 30,000 g/mol. In one embodiment the silicone resin may be described in the terms of a molar fraction as an MQ silicone resin having the formula:

(R⁴₃SiO_{1/2})ᵤ(SiO_{4/2})ᵥ

wherein R⁴ is a C₁ to C₁₀ hydrocarbon group free of aliphatic unsaturation, u is from 0.3 to 0.6, alternatively 0.37 to 0.52, v is from 0.4 to 0.7, alternatively 0.48 to 0.63, and the value of u+v is 1.0.

Methods of preparing silicone resins are well known in the art. For example, they may be made by treating a resin copolymer produced by a silica hydrosol capping process with an alkyl and/or alkenyl containing end-blocking agent. This preferably includes reacting a silica hydrosol under acidic conditions with a hydrolysable triorganosilane such as trimethylchlorosilane, a siloxane such as hexamethyldisiloxane, and combinations thereof, and then recovering a copolymer having M (R₃SiO_{1/2}) units and Q (SiO_{4/2}) units including 0.07 to 0.2 moles hydroxyl per mole of silicon (Si). The copolymer may be further reacted with an end-blocking agent including saturated organic groups to achieve the less than 0.06 moles hydroxyl per mole Si. Suitable end-blocking agents include silazanes, siloxanes, silanes, and combinations thereof.

The trialkyl terminated polydiorganosiloxane of (e) (ii) may be of any suitable viscosity for example may have a viscosity of from 1000 to 100,000 mPa·s at 25° C. alternatively from 5000 to 80,000 mPa·s at 25° C., alternatively from 10,000 to 70,000 mPa·s at 25° C. Each alkyl terminal group may be the same or different having from 1 to 20 carbons, alternatively 1 to 15 carbons, alternatively 1 to 12 carbons, alternatively 1 to 10 carbons. Specific examples of alkyl groups may include methyl, ethyl, propyl, pentyl, octyl, undecyl, and octadecyl groups, alternatively methyl and ethyl groups.

Preferably they are methyl groups. The organo groups of the trialkyl terminated polydiorganosiloxane of (e) (ii) are the same as the R′, excluding the unsaturated groups described above in respect of component (a), i.e., selected from an aliphatic hydrocarbyl group, a substituted aliphatic hydrocarbyl group, an aromatic group or a substituted aromatic group. Each aliphatic hydrocarbyl group may be exemplified by, but not limited to, alkyl groups having from 1 to 20 carbons per group, alternatively 1 to 15 carbons per group, alternatively 1 to 12 carbons per group, alternatively 1 to 10 carbons per group, alternatively 1 to 6 carbons per group or cycloalkyl groups such as cyclohexyl. Specific examples of alkyl groups may include methyl, ethyl, propyl, pentyl, octyl, undecyl, and octadecyl groups, alternatively methyl and ethyl groups. Substituted aliphatic hydrocarbyl group are preferably non-halogenated substituted alkyl groups. As previously indicated unless otherwise indicated all viscosity measurement given are zero-shear viscosity (ηₒ) values measured as previously described.

Component (e) may be present in the composition in an amount of from 1-60 wt. %, alternatively 1-40 wt. %, and is preferably, in the case of (e) (i) is in the form of an MQ resin.

Components (a), (c), (e) (i) and (e) (ii) invariably consist of a mixture of macromolecular species with different degrees of polymerization and therefore of different molecular weights. There are different types of average polymer molecular weight, which can be measured in different experiments. The two most important are the number average molecular weight (Mn) and the weight average molecular weight (Mw). The Mn and Mw of a silicone polymer and/or resin can be determined by Gel permeation chromatography (GPC) using polystyrene calibration standards. This technique is standard and yields Mw, Mn and polydispersity index (PI). The degree of polymerisation (DP)=Mn/Mu where Mn is the number-average molecular weight coming from the GPC measurement and Mu is the molecular weight of a monomer unit. PI=Mw/Mn. The DP is linked to the viscosity of the polymer via Mw, the higher the DP, the higher the viscosity. The silicone resin typically has a weight-average molecular weight (M_{w}) of from 2,000 to 50,000 Daltons, alternatively from 3,000 to 40,000, alternatively from 3,000 to 30,000, alternatively from 4,000 to 30,000, alternatively 5,000 to 25,000 where the molecular weight is determined by gel permeation chromatography employing a triple detector system e.g., light-scattering detector, a refractive index detector, and/or a viscosity detector and polystyrene standards.

### (f) Adhesion Promoter

The hydrosilylation curable silicone coating composition used to prepare the coating for the one-piece woven airbag additionally comprises an adhesion promoter (f). Adhesion promoter (f) may be any suitable adhesion promoter that will not be detrimental to the physical properties of the cured coating on the airbag. For example, one or more monoacrylates, diacrylates or methacrylates. Examples may include for diacrylates such as C₄₋₂₀ alkanediol diacrylate such as hexanediol diacrylate, heptanediol diacrylate, octanediol diacrylate, nonanediol diacrylate, and or undecanediol diacrylate. Examples of monoacrylates include alkoxysilanes containing methacrylic groups or acrylic groups such as methacryloxymethyl-trimethoxysilane, 3-methacryloxypropyl-trimethoxysilane, 3-methacryloxypropyl-methyldimethoxysilane, 3-methacryloxypropyl-dimethylmethoxysilane, 3-methacryloxypropyl-triethoxysilane, 3-methacryloxypropyl-methyldiethoxysilane, 3-methacryloxyisobutyl-trimethoxysilane, or a similar methacryloxy-substituted alkoxysilane; 3-acryloxypropyl-trimethoxysilane, 3-acryloxypropyl-methyldimethoxysilane, 3-acryloxypropyl-dimethyl-methoxysilane, 3-acryloxypropyl-triethoxysilane, or a similar acryloxy-substituted alkyl-containing alkoxysilane.

Examples of epoxy-containing alkoxysilanes which may be used as adhesion promoter may include 3-glycidoxypropyl trimethoxysilane, 3-glycidoxypropyl triethoxysilane, 3-glycidoxypropyl methyldimethoxysilane, 4-glycidoxybutyl trimethoxysilane, 5,6-epoxyhexyl triethoxysilane, 2-(3,4-epoxycyclohexyl) ethyltrimethoxysilane, or 2-(3,4-epoxycyclohexyl) ethyltriethoxysilane.

The adhesion promoter (f) may alternatively include alkoxysilane containing methacrylic groups or acrylic groups such as methacryloxymethyl-trimethoxysilane, 3-methacryloxypropyl-tirmethoxysilane, 3-methacryloxypropyl-methyldimethoxysilane, 3-methacryloxypropyl-dimethylmethoxysilane, 3-methacryloxypropyl-triethoxysilane, 3-methacryloxypropyl-methyldiethoxysilane, 3-methacryloxyisobutyl-trimethoxysilane, or a similar methacryloxy-substituted alkoxysilane; 3-acryloxypropyl-trimethoxysilane, 3-acryloxypropyl-methyldimethoxysilane, 3-acryloxypropyl-dimethyl-methoxysilane, 3-acryloxypropyl-triethoxysilane, or a similar acryloxy-substituted alkyl-containing alkoxysilane.

The adhesion promoter (f) may alternatively include an adhesion promoter comprising a mixture and/or reaction product of
i) one or more alkoxysilanes having an epoxy group in the molecule;
ii) a linear organopolysiloxane oligomer containing at least one alkenyl group and at least one hydroxy or alkoxy group per molecule; and
iii) an organometallic condensation reaction catalyst comprising organoaluminum or organozirconium compounds.

In such a case (f)(i) the one or more alkoxysilanes having an epoxy group in the molecule may be 3-glycidoxypropyl trimethoxysilane, 3-glycidoxypropyl triethoxysilane, 3-glycidoxypropyl methyldimethoxysilane, 4-glycidoxybutyl trimethoxysilane, 5,6-epoxyhexyl triethoxysilane, 2-(3,4-epoxycyclohexyl) ethyltrimethoxysilane, or 2-(3,4-epoxycyclohexyl) ethyltriethoxysilane; and (f)(ii) the linear organopolysiloxane oligomer containing at least one alkenyl group and at least one hydroxy or alkoxy group per molecule can for example be a methylvinylpolysiloxane in which both molecular terminals are dimethylhydroxysiloxy units, or a copolymer of a methylvinyl siloxane and dimethylsiloxane units in which both molecular terminals are dimethylhydroxysiloxy units. The oligomeric organopolysiloxane can be a mixture of organopolysiloxane molecules, some of which have silanol end groups at both molecular terminals and some of which have only one silanol group such as a dimethylhydroxysiloxy terminal unit with the other terminal unit being for example a dimethylmethoxysiloxy unit, a trimethylsiloxy unit or a dimethylvinylsiloxy unit. Preferably more than 50% by weight of the oligomeric organopolysiloxane, more preferably 60-100% comprises molecules having silanol end groups at both molecular terminals.

The oligomeric organopolysiloxane preferably contains at least 3%, more preferably at least 5%, by weight vinyl groups, and can contain up to 35 or 40% by weight vinyl groups. Most preferably the oligomeric organopolysiloxane contains 5 to 30% by weight vinyl groups. The oligomeric organopolysiloxane preferably has a molecular weight of 1000 to 10000. The oligomeric organopolysiloxane preferably has a viscosity of from 0.1 to 300 mPa·s, alternatively a viscosity of 0.1 to 200 mPa·s, alternatively from 1 to 100 mPa·s. (measured using a Brookfield DV 3T Rheometer at 25° C.). Component (f)(ii) may be present in the composition in an amount of from 0.1 to 5% by weight of the composition, alternatively 0.1 to 3% by weight, alternatively 0.1 to 2% by weight of the composition.

The third part of the adhesion promoter (f)(iii) is an organometallic condensation reaction catalyst comprising organoaluminum or organozirconium compounds which may be used to catalyse the reaction of the other components of the adhesion promoter, namely (f(i) and (ii) and is used to activate and/or accelerate the reaction between them. The condensation catalyst may be selected from organometallic catalyst comprising zirconates, organoaluminium chelates, and/or zirconium chelates.

Zirconate based catalysts may comprise a compound according to the general formula or Zr[OR⁵]₄ where each R⁵ may be the same or different and represents a monovalent, primary, secondary or tertiary aliphatic hydrocarbon group which may be linear or branched containing from 1 to 20 carbon atoms, alternatively 1 to 10 carbon atoms. Optionally the zirconate may contain partially unsaturated groups. Preferred examples of R⁵ include but are not restricted to methyl, ethyl, propyl, isopropyl, butyl, tertiary butyl and a branched secondary alkyl group such as 2,4-dimethyl-3-pentyl. Preferably, when each R⁵ is the same, R⁵ is an isopropyl, branched secondary alkyl group or a tertiary alkyl group, in particular, tertiary butyl. Specific examples include, zirconium tetrapropylate and zirconium tetrabutyrate, tetra-isopropyl zirconate, zirconium (IV) tetraacetyl acetonate, (sometimes referred to as zirconium AcAc₄, zirconium (IV) hexafluoracetyl acetonate, zirconium (IV) trifluoroacetyl acetonate, tetrakis (ethyltrifluoroacetyl acetonate) zirconium, tetrakis (2,2,6,6-tetramethyl-heptanethionate) zirconium, zirconium (IV) dibutoxy bis(ethylacetonate), zirconium tributoxyacetylacetate, zirconium butoxyacetylacetonate bisethylacetoacetate, zirconium butoxyacetylacetonate bisethylacetoacetate, diisopropoxy bis (2,2,6,6-tetramethyl-heptanethionate) zirconium, or similar zirconium complexes having β-diketones (including alkyl-substituted and fluoro-substituted forms thereof) which are used as ligands.

Suitable aluminium-based condensation catalysts may include but are not limited to one or more of Al(OC₃H₇)₃, Al(OC₃H₇)₂(C₃COCH₂COC₁₂H₂₅), Al(OC₃H₇)₂(OCOCH₃), and Al(OC₃H₇)₂(OCOC₁₂H₂₅).

Component (f)(iii) may be present in the composition in an amount of from 0.1 to 5% by weight of the composition, alternatively 0.1 to 3% by weight, alternatively 0.1 to 2% by weight of the composition. When adhesion promoter (f) is comprises a cumulative amount of (f)(i), (ii) and (iii), it may comprise from about 0.3 to 6 wt. % of the composition; alternatively, 0.3 to 4 wt. % of the composition.

The adhesion promoter provides a strong bonding performance between the resulting coating and the fabric substrate, including woven fabrics.

### Additional Optional Ingredients

Additional optional ingredients may be present in the liquid silicone rubber composition as hereinbefore described depending on the intended final use thereof. Examples of such optional ingredients include cure inhibitors thermally conductive fillers, pot life extenders, flame retardants, lubricants, non-reinforcing fillers, pigments and/or colouring agents, bactericides, wetting agents, heat stabilizers, compression set additives, plasticizers, and mixtures thereof.

When the hydrosilylation curable silicone coating composition as hereinbefore described is being cured via an addition/hydrosilylation reaction an inhibitor may be utilized to inhibit the cure of the composition. These inhibitors are utilized to prevent premature cure in storage and/or to obtain a longer working time or pot life of a hydrosilylation cured composition by retarding or suppressing the activity of the catalyst. Inhibitors of hydrosilylation catalysts (d), e.g., platinum metal-based catalysts are well known in the art and may include hydrazines, triazoles, phosphines, mercaptans, organic nitrogen compounds, acetylenic alcohols, silylated acetylenic alcohols, maleates, such as dibutyl maleate; fumarates, ethylenically or aromatically unsaturated amides, ethylenically unsaturated isocyanates, olefinic siloxanes, such as tetramethyltetravinylcyclotetrasiloxane; unsaturated hydrocarbon monoesters and diesters, conjugated ene-ynes, hydroperoxides, nitriles, and diaziridines. Alkenyl-substituted siloxanes as described in U.S. Pat. No. 3,989,667 may be used, of which cyclic methylvinylsiloxanes are preferred.

One class of known inhibitors of hydrosilylation catalysts, e.g., platinum catalysts (d) include the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C. or above to cure at a practical rate.

Examples of acetylenic alcohols and their derivatives include 1-ethynyl-1-cyclohexanol (ETCH), 2-methyl-3-butyn-2-ol, 3-butyn-1-ol, 3-methyl butynol 3-butyn-2-ol, propargyl alcohol, 2-phenyl-2-propyn-1-ol, 3,5-dimethyl-1-hexyn-3-ol, 1-ethynylcyclopentanol, 1-phenyl-2-propynol, 3-methyl-1-penten-4-yn-3-ol, and mixtures thereof. In one alternative the inhibitor is selected from one or more of 1-ethynyl-1-cyclohexanol (ETCH), tetramethyltetravinylcyclotetrasiloxane, 3-methyl butynol and/or dibutyl maleate.

When present, inhibitor concentrations as low as 1 mole of inhibitor per mole of the metal of catalyst (d) will in some instances impart satisfactory storage stability and cure rate. In other instances, inhibitor concentrations of up to 500 moles of inhibitor per mole of the metal of catalyst (d) are required. The optimum concentration for a given inhibitor in a given hydrosilylation curable silicone coating composition herein is readily determined by routine experimentation. Mixtures of the above may also be used. Dependent on the concentration and form in which the inhibitor selected is provided/available commercially, when present in the composition, the inhibitor is typically present in an amount of from 0.0001-10 wt. %, alternatively 0.001-5%, inhibitor, alternatively 0.0125 to 5 wt. % of the composition. Pot life extenders, such as triazole, may be used, but are not considered necessary in the scope of the present invention. The liquid curable silicone rubber composition may thus be free of pot life extender.

Examples of flame retardants include aluminium trihydrate, chlorinated paraffins, hexabromocyclododecane, triphenyl phosphate, dimethyl methylphosphonate, tris(2,3-dibromopropyl) phosphate (brominated tris), and mixtures or derivatives thereof.

Examples of lubricants include tetrafluoroethylene, resin powder, graphite, fluorinated graphite, talc, boron nitride, fluorine oil, silicone oil, molybdenum disulfide, and mixtures or derivatives thereof. When present in the composition, flame retardants are typically present in an amount of from 0.1 to 5% by weight of the composition.

Non-reinforcing fillers may include crushed quartz, diatomaceous earths, barium sulphate, iron oxide, titanium dioxide and carbon black, talc, wollastonite. Other fillers which might be used alone or in addition to the above include aluminite, calcium sulphate (anhydrite), gypsum, calcium sulphate, magnesium carbonate, clays such as kaolin, aluminium trihydroxide, magnesium hydroxide e.g., brucite, graphite, copper carbonate, e.g., malachite, nickel carbonate, e.g., zarachite, barium carbonate, e.g., witherite and/or strontium carbonate e.g., strontianite.

Other fillers may include, aluminium oxide, silicates from the group consisting of olivine group; gamet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₂; grossular; and Ca₂Al₂Si₃O₁₂. Aluminosilicates comprise ground silicate minerals, such as but not limited to, sillimanite; Al₂SiO₅; mullite; 3Al₂O₃·2SiO₂; kyanite; and Al₂SiO₅. Ring silicates may be utilized as non-reinforcing fillers, these include silicate minerals, such as but not limited to, cordierite and Al₃(Mg,Fe)₂[Si₄AlO₁₈]. The chain silicates group comprises ground silicate minerals, such as but not limited to, wollastonite and Ca[SiO₃]. Sheet silicates may alternatively or additionally be used as non-reinforcing fillers where appropriate group comprises silicate minerals, such as but not limited to, mica; K₂AI₁₄[Si₆Al₂O₂₀](OH)₄; pyrophyllite; Al₄[Si₈O₂₀](OH)₄; talc; Mg₆[Si₈O₂₀](OH)₄; serpentine for example, asbestos; Kaolinite; A14[Si₄O₁₀](OH)₈; and vermiculite. In one alternative the fillers will be selected from one or more of fumed silica, precipitated silica, calcium carbonate, talc, mica, quartz and aluminium oxide.

Examples of pigments include titanium dioxide, chromium oxide, bismuth vanadium oxide, iron oxides and mixtures thereof.

Examples of colouring agents for which may be utilized in the hydrosilylation curable silicone coating composition include pigments, vat dyes, reactive dyes, acid dyes, chrome dyes, disperse dyes, cationic dyes and mixtures thereof. The two-part moisture cure organopolysiloxane composition as described herein may further comprise one or more pigments and/or colorants which may be added if desired. The pigments and/or colorants may be coloured, white, black, metal effect, and luminescent e.g., fluorescent and phosphorescent. Pigments are utilized to colour the composition as required. Any suitable pigment may be utilized providing it is compatible with the composition herein. In two-part moisture cure organopolysiloxane compositions pigments and/or coloured (non-white) fillers e.g., carbon black may be utilized in the catalyst package to colour the end sealant product.

Suitable white pigments and/or colorants include titanium dioxide, zinc oxide, lead oxide, zinc sulfide, lithophone, zirconium oxide, and antimony oxide.

Suitable non-white inorganic pigments and/or colorants include, but are not limited to, iron oxide pigments such as goethite, lepidocrocite, hematite, maghemite, and magnetite black iron oxide, yellow iron oxide, brown iron oxide, and red iron oxide; blue iron pigments; chromium oxide pigments; cadmium pigments such as cadmium yellow, cadmium red, and cadmium cinnabar; bismuth pigments such as bismuth vanadate and bismuth vanadate molybdate; mixed metal oxide pigments such as cobalt titanate green; chromate and molybdate pigments such as chromium yellow, molybdate red, and molybdate orange; ultramarine pigments; cobalt oxide pigments; nickel antimony titanates; lead chrome; carbon black; lampblack, and metal effect pigments such as aluminium, copper, copper oxide, bronze, stainless steel, nickel, zinc, and brass.

Suitable organic non-white pigments and/or colorants include phthalocyanine pigments, e.g. phthalocyanine blue and phthalocyanine green; monoarylide yellow, diarylide yellow, benzimidazolone yellow, heterocyclic yellow, DAN orange, quinacridone pigments, e.g. quinacridone magenta and quinacridone violet; organic reds, including metallized azo reds and nonmetallized azo reds and other azo pigments, monoazo pigments, diazo pigments, azo pigment lakes, β-naphthol pigments, naphthol AS pigments, benzimidazolone pigments, diazo condensation pigment, isoindolinone, and isoindoline pigments, polycyclic pigments, perylene and perinone pigments, thioindigo pigments, anthrapyrimidone pigments, flavanthrone pigments, anthanthrone pigments, dioxazine pigments, triarylcarbonium pigments, quinophthalone pigments, and diketopyrrolo pyrrole pigments.

Typically, the pigments and/or colorants, when particulates, have average particle diameters in the range of from 10 nm to 50 μm, preferably in the range of from 40 nm to 2 μm. The pigments and/or colorants when present are present in the range of from 2, alternatively from 3, alternatively from 5 to 20 wt. % of the catalyst package composition, alternatively to 15 wt. % of the catalyst package composition, alternatively to 10 wt. % of the catalyst package composition.

In a preferred embodiment of the invention, the pigments and dyes are used in form of pigment masterbatch composed of them dispersed in component (a) at the ratio of 25:75 to 70:30.

The hydrosilylation curable silicone coating composition may be a heat stabilised hydrosilylation curable silicone coating composition. Examples of heat stabilizers may include metal compounds such as red iron oxide, yellow iron oxide, ferric hydroxide, cerium oxide, cerium hydroxide, lanthanum oxide, copper phthalocyanine, aluminium hydroxide, fumed titanium dioxide, iron naphthenate, cerium naphthenate, cerium dimethylpolysilanolate and acetylacetone salts of a metal chosen from copper, zinc, aluminum, iron, cerium, zirconium, titanium and the like. Other examples of heat stabilizers may include suitable antioxidants or metal scavengers such as salicyloylaminotriazole, 1,2-bis(3,5-di-tert-butyl-4-hydroxylhydrocinnamoyl)hydrazine, 2-Hydroxy-N-1H-1,2,4-triazol-3-ylbenzamide, and N′1,N′12-Bis(2-hydroxybenzoyl)dodecanedihydrazide. The amount of heat stabilizer when present in the hydrosilylation curable silicone coating composition may range from 0.01 to 1.0% weight of the total composition.

In one embodiment the one-piece woven airbag comprising a coating having a mean dry coat weight of from 45 to 62 g/m² determined in accordance with ISO 3801, is the cured elastomeric product of a hydrosilylation curable silicone coating composition comprising:
a) an organopolysiloxane polymer (a) having a viscosity of from In each case component (a) The viscosity of organopolysiloxane polymer (a) should be between 100 and 200,000 mPa·s inclusive at 25° C., alternatively from 1000 to 150,000 mPa·s at 25° C., alternatively, from 1000 mPa·s to 125,000 mPa·s, alternatively from 1000 mPa·s to 70,000 mPa·s at 25° C., having at least two unsaturated groups per molecule selected from alkenyl and/or alkynyl groups, in an amount of from 40 wt. % to about 80 wt. % of the composition, alternatively from 45 to 80 wt. % of the composition, alternatively from 50 to 80 wt. % of the composition of the composition;
b) reinforcing fillers comprising fumed silica and/or precipitated silica, having a particle size of at least 50 m²/g (BET method in accordance with ISO 9277: 2010) alternatively, 50-450 m²/g, alternatively, 50-400 m²/g m²/g, alternatively from 50 to 300 m²/g, alternatively 100-300 m²/g (BET method in accordance with ISO 9277: 2010); said reinforcing fillers (b) are typically treated to render them hydrophobic and are present in an amount of from 1.0 to 50 wt. %. of the composition, alternatively of from 1 to 30 wt. %. of the composition, alternatively of from 5.0 to 25 wt. %. based on the weight % of the composition;
c) an organosilicon compound having at least two, alternatively at least three Si—H groups per molecule, preferably wherein the molar ratio of the silicon-bonded hydrogen atoms in component (c) to the total unsaturated groups selected from alkenyl and/or alkynyl groups in the composition is from 0.5:1 to 20:1, alternatively the molar ratio of silicon-bonded hydrogen atoms of component (c) to the total unsaturated groups selected from alkenyl and/or alkynyl groups in the organopolysiloxane (a) is preferably at least 1:1 and can be up to 8:1 or 10:1. Most preferably the molar ratio of Si—H groups to aliphatically unsaturated groups is in the range from 1.1:1 to 5:1; said organosilicon compound having at least two, alternatively at least three Si—H groups per molecule being present in an amount of from 0.1 to 10 wt. % of the hydrosilylation curable silicone coating composition, alternatively 0.1 to 7.5 wt. % of the hydrosilylation curable silicone coating composition, alternatively 0.5 to 7.5 wt. %, further alternatively from 0.5% to 5 wt. % of the hydrosilylation curable silicone coating composition. Component (c) functions as a cross-linker.
d) a hydrosilylation cure catalyst wherein the catalytic amount of the hydrosilylation catalyst is between 0.01 ppm, and 10,000 parts by weight of platinum-group metal, per million parts (ppm), based on the weight of the composition; alternatively, between 0.01 and 5000 ppm; alternatively, between 0.01 and 3,000 ppm, and alternatively between 0.01 and 1,000 ppm; alternatively 0.01 to 750 ppm, alternatively 0.01 to 500 ppm and alternatively 0.01 to 100 ppm of metal based on the weight of the composition and wherein dependent on the form/concentration in which the catalyst is provided e.g., in a polymer or solvent, the amount of component (d) present will be within the range of from 0.001 to 3.0 wt. % of the composition, alternatively from 0.001 to 1.5 wt. % of the composition, alternatively from 0.01-1.5 wt. %, alternatively 0.01 to 0.1.0 wt. %, of the hydrosilylation curable silicone coating composition;
e) one or more substantially non-functional organosilicon compounds selected from
   (i) silicone resins selected from T silicone resins (silsesquioxanes), DT silicone resins, MQ silicone resins, MDT silicone resins, MTQ silicone resins, QDT silicone resins or mixtures thereof and/or
   (ii) a trialkyl terminated polydiorganosiloxane, in an amount of from 1-60 wt. %, alternatively 1-40 wt. % of the composition;
f) an adhesion promoter selected from one or more monoacrylates, diacrylates or methacrylates; epoxy-containing alkoxysilanes, alkoxysilane containing methacrylic groups or acrylic groups and a mixture and/or reaction product of
   i) one or more alkoxysilanes having an epoxy group in the molecule in an amount of from 0.1 to 5% by weight of the composition, alternatively 0.5 to 3% by weight, alternatively 0.5 to 2% by weight of the composition;
   ii) a linear organopolysiloxane oligomer containing at least one alkenyl group and at least one hydroxy or alkoxy group per molecule in an amount of from 0.1 to 5% by weight of the composition, alternatively 0.1 to 3% by weight, alternatively 0.1 to 2% by weight of the composition; and
   iii) an organometallic condensation reaction catalyst comprising organoaluminum or organozirconium compounds in an amount of from 0.1 to 5% by weight of the composition, alternatively 0.1 to 3% by weight, alternatively 0.1 to 2% by weight of the composition; or a mixture thereof;
      which adhesion promoter (f) is typically present in the composition in a cumulative amount of (f)(i), (ii) and (iii) of from about 0.3 to 6 wt. % of the composition; alternatively, 0.3 to 4 wt. % of the composition; the composition may be any combination of the above ranges providing the total wt. % is 100 wt. %.

Typically, prior to use the composition utilized to make the coating of the one-piece woven airbag is stored in two parts, Part A and part B to keep components (c) (cross-linker) and (d) hydrosilylation cure catalyst apart to avoid premature cure. Typically, a Part A composition will comprise components (a) polymer, (b) reinforcing filler and (d) hydrosilylation cure catalyst and Part B will comprise components (a), (b) and (c) cross-linker and inhibitor when present. Both component (e) (i) and/or (ii) above may be present in either or both Part A and Part B. Regarding the adhesion promoter, when utilizing the reaction product of (f) (i), (f) (ii) and (f) (iii), to prevent premature reaction, component f) (iii) is usually stored in part A and components f (i) and (ii) are stored in part B.

Additives when present in the composition may be in either Part A or Part B, providing they do not negatively affect the properties of any other component (e.g., catalyst inactivation). Part A and part B of the hydrosilylation curable silicone coating composition described herein are mixed together shortly prior to use to initiate cure of the full composition into a silicone elastomeric material. The compositions can be designed to be mixed in any suitable ratio e.g., part A:part B may be mixed together in ratios of from 10:1 to 1:10, alternatively from 5:1 to 1:5, alternatively from 2:1 to 1:2, but most preferred is a ratio of 1:1.

Ingredients in each of Part A and/or Part B may be mixed together individually or may be introduced into the composition in pre-prepared in combinations for, e.g., ease of mixing the final composition. For Example, components (a) and (b) are often mixed together to form an LSR polymer base or masterbatch prior to addition with other ingredients. These may then be mixed with the other ingredients of the Part being made directly or may be used to make pre-prepared concentrates commonly referred to in the industry as masterbatches.

In this instance, for ease of mixing ingredients, one or more masterbatches may be utilized to successfully mix the ingredients to form Part A and/or Part B compositions. For example, a “fumed silica” masterbatch may be prepared. This is effectively an LSR silicone rubber base with silica treated in situ.

Parts A and B of the composition may be prepared by combining all of their respective components at ambient temperature. Any mixing techniques and devices described in the prior art can be used for this purpose. The particular device to be used will be determined by the viscosities of components and the final composition. Suitable mixers include but are not limited to paddle type mixers e.g., planetary mixers and kneader type mixers. Cooling of components during mixing may be desirable to avoid premature curing of the composition.

Prior to use the respective Part A and Part B compositions are mixed together in the desired ratio. As part of the method herein the coating composition as hereinbefore described may be applied on to a fabric substrate, typically a one-piece woven airbag substrate by any suitable known technique. These include spraying, gravure coating, bar coating, coating by knife-over-roller, coating by knife-over-air, padding, dipping and screen-printing. The coating composition can be applied to an airbag fabric which is to be cut into pieces and sewn to assemble an airbag, or to a one-piece woven airbag but is particularly designed for retaining the one-piece woven airbag in an inflated form for the several seconds after a collision and as such is most suited for use with side-curtain airbags which generally are one-piece woven given these are far better designed to avoid gas leakage/permeability after deployment and given it is said side-curtain airbags which are mainly the type which are maintained inflated for the critical seconds immediately after a collision to protect the occupants of the vehicle or the like.

Curing of the hydrosilylation curable silicone coating composition of the present invention applied onto the woven fabric is typically carried out by heating the composition at a temperature of from 150 to 200° C. for 1 to 2 minutes.

Although it is not preferred, it is possible to apply the composition in multiple layers, which together have the mean dry coat weights set out above. It is also possible to apply onto the coating composition a further compatible coating, e.g., of a material providing e.g., low friction, if deemed necessary.

The present disclosure includes a one-piece woven airbag comprising a coating having a mean dry coat weight of from 45 to 62 g/m² determined in accordance with ISO 3801 and a method of preparing the coated one-piece woven airbag. The one-piece woven airbag may be made from any suitable woven fabric, particularly a plain weave fabric, but can for example be a knitted or nonwoven fabric. The fabric may be made from synthetic fibres or blends of natural and synthetic fibres, for example polyamide fibres such as Nylon 6, Nylon 66 and Nylon 46; polyester fibers such as polyethylene terephthalate and polybutylene terephthalate; polyimide, polyethylene, polypropylene, polyester-cotton, polyacrylonitrile fiber fabric, aramid fiber fabric, polyether imide fiber fabric, polysulfone fiber fabric, carbon fiber fabric, rayon fiber fabric and/or glass fibres. For example, it is preferable to use polyamide fiber fabric or polyester fiber fabric for applications requiring high strength, such as automotive one-piece woven airbags. Prior to coating with the liquid curable silicone rubber composition of the present invention, the woven fabric is preferably washed with water and dried.

For use as one-piece woven airbag fabric, the fabric should be sufficiently flexible to be able to be folded into relatively small volumes, but also sufficiently strong to withstand deployment at high speed, e.g., under the influence of an explosive charge. Polyamide and polyester fibres are particularly preferred for making airbag textiles; however, it can be difficult to get coatings to adhere to polyamide and polyester airbags, hence the need for adhesion promoters such as component (f) in the compositions described above as the coating compositions as hereinbefore described need to have good adhesion to plain weave nylon and polyester fabrics. The coating compositions described herein are designed therefore to have particularly good adhesion and film forming properties immediately on contacting the fabric, so that film formation on the surface of the fabric being coated is uniform. Preferably they also have good penetration into the fabric in order for the ability to achieve a lower than usual mean dry coat weight, e.g., of from 45 to 62 g/m², alternatively from 50 to 62 g/m² determined in accordance with ISO 3801, whilst unexpectedly obtaining a cured coating having loss tangent (tan δ) value of at least 0.175.

The loss tangent (tan δ) value represents the ability of the cured product of the composition described herein to dissipate energy relative to the ability to store energy. Since the cured coating is viscoelastic, when a deformation like shear occurs (or in this instance when an airbag is deployed due to a collision), some of the energy gets stored elastically (represented by G′), while the rest is dissipated as heat (represented by G″). Higher loss tangent (tan δ) values are better for absorbing energy for impact to reduce the amount of damage incurred upon deformation and as such a more dissipative material will not incur as much damage upon deployment of the one-piece woven airbag.

In addition, preferably such an airbag when coated using the composition described herein will avoid immediate deflation and will have a greater than 60% inner pressure-holding properties retained after 6 seconds, alternatively equal or greater than 62% inner pressure-holding properties retained after 6 seconds, from deployment using the test method described above. Despite having a thinner coating on the one-piece woven airbag than traditional coatings for side-curtain airbags one is able to retain reduced gas permeability and/or good air tightness during the period of time in curtain airbags following a collision and subsequent rollover, e.g., about 6 seconds, thus avoiding full deflation and providing protection to occupants during the critical period of the first few seconds after a collision.

The coated one-piece woven airbag obtained by coating an uncoated one-piece woven airbag with the hydrosilylation curable silicone coating composition described herein has at least one coating layer formed of a cured product from the hydrosilylation curable silicone coating composition described herein. If necessary, however, one or more additional layers may be provided on the coated woven fabric. Such additional layers are applied typically for improving the tactile sensation of the surface of a coated woven fabric, for improving abrasion resistance of the surface of a coated woven fabric, and/or for improving the strength of a coated woven fabric. The additional coating layer may be exemplified by a plastic film, a woven fabric, a non-woven fabric, or a coating layer formed of an elastic coating material other than the cured silicone rubber of the present invention. Preferably no additional layers are required or desired.

This technology can be used in any suitable one-piece woven airbag application, particularly in the automobile market but also for e.g., escape chutes from aircraft. The airbag coated with the cured product of a curable silicone composition that when coated on one-piece woven airbags, can be coated at a lower mean dry coat weight than incumbent material. This consequently provides an overall lower total cost of ownership for manufacturers, due to the reduction in the amount of silicone coating needed, as well as achieving a reduction in mass for vehicle light weighting considerations. Advantageously, said reduction in mean dry coat weight is accompanied with a coated airbag having the ability to sustain a sufficiently long inflation time and to allow the one-piece woven airbag to protect the occupants throughout the duration of impact encountered, for example, in a vehicle rollover accident.

### EXAMPLES

In the following examples, the compositions are defined in weight % (wt. %) unless otherwise stated.

Vinyl group and Si—H group content was measured by Infrared spectroscopy in accordance with ASTM E168 using standards of the carbon double bond stretch and silicon-hydrogen bond stretch respectively.

### Determination of Viscosity

Unless otherwise indicated all viscosity measurement given are zero-shear viscosity (ηₒ) values, obtained by extrapolating to zero the value taken at low shear rates (or simply taking an average of values) in the limit where the viscosity-shear rate curve is rate-independent, which is a test-method independent value provided a suitable, properly operating rheometer is used. The viscosity measurements were obtained using an ARES-G2 rotational rheometer, commercially available from TA Instruments using a steady rate sweep from 0.1 to 10 s⁻¹ on a 25 mm cone and plate. If the zero-shear plateau region cannot be observed at shear rates accessible to the rheometer or viscometer, we report the viscosity measured at a standard shear rate of 0.1 s⁻¹ at 25° C.

A comparative example was prepared in which a M^{vi}Q resin was included and two examples in accordance with the composition described above was also prepared using the compositions provided in Table 1. The compositions were prepared as two-part compositions.

TABLE 1a
Part A compositions of Ex. 1 and 2 and C. 1

| Description | C. 1 | Ex. 1 | Ex. 2 |
|---|---|---|---|
| Treated filler in Polymer 1 | 54.75 | 56.30 | 58.27 |
| Polymer 1 | | 16.01 | 30.39 |
| Polymer 2 | | | 1.38 |
| Catalyst in Polymer 2 | 0.28 | 0.29 | 0.33 |
| M^{vi}Q resin in Polymer 1 | 44.45 | | |
| MQ resin in Polymer 1 | | 26.87 | |
| Adhesion Package Component 3 in Polymer 2 | 0.51 | 0.53 | 0.55 |
| Polymer 3 | | | 9.09 |

TABLE 1b
Part B compositions of Ex. 1 and 2 and C. 1

| Description | C. 1 | Ex. 1 | Ex. 2 |
|---|---|---|---|
| Treated filler in Polymer 1 | 51.39 | 58.22 | 58.10 |
| Polymer 1 | | 11.42 | 23.21 |
| Polymer 2 | 1.21 | 1.38 | |
| Cross-linker | 12.67 | 5.99 | 6.01 |
| M^{vi}Q resin in Polymer 1 | 31.37 | | |
| MQ resin in Polymer 1 | | 19.15 | |
| Adhesion Package Component 1 | 0.96 | 1.08 | 1.09 |
| Adhesion Package Component 2 | 0.24 | 0.27 | 0.27 |
| Inhibitor in Polymer 2 | 1.96 | 2.22 | 2.23 |
| Polymer 3 | | | 9.09 |
| heat stabilization additive | 0.20 | 0.27 | |

Polymer 1 was a dimethylvinylsiloxy-terminated Dimethyl Siloxane having a 0.085 wt. % Vinyl content and a viscosity of 57,000 mPa·s at 25° C.;
Treated filler Polymer 1 was 29.8 wt. % CAB-O-SIL™ MS-75D fumed silica (commercially available from Cabot Corporation) which was treated in situ with hexamethyldisilazane (HMDZ);
Polymer 2 was a Dimethylvinylsiloxy-terminated Dimethyl Siloxane, having a 0.42 wt. % vinyl content and a viscosity of 400 mPa·s at 25° C.;
Polymer 3 was a trimethyl terminated polydimethylsiloxane having a viscosity of 60,000 mPa·s at 25° C.;
The cross-linker was a Trimethylsiloxy-terminated Dimethyl, Methylhydrogen Siloxane, having an Si—H content of 0.46 wt. % and a viscosity of 5.3 mPa·s;
The catalyst used was Karstedt's catalyst;
M^{vi}Q resin in Polymer 1 was an MQ resin having dimethylvinyl M groups in a mixture comprising 27 wt. % M^{vi}Q resin in Polymer 1 with the blend having a combined 0.66 wt. % Vinyl content;
MQ resin in Polymer 1 was a non-functional silicone resin having the (mole fraction) formula: (Me₃SiO_{1/2})ᵤ(SiO_{4/2}), wherein Me is methyl, u is from 0.3 to 0.6, v is from 0.4 to 0.7, and the value of u+v is 1.0. The MQ resin was present in the mixture with polymer 1 in an amount of 45 wt. %;
Adhesion package component 1 was Gamma-glycidoxypropyl trimethoxy silane;
Adhesion package component 2 was a dimethylhydroxy terminated Dimethyl, Methylvinyl Siloxane, having a vinyl content of 11.2 wt. % and a viscosity of 23 mPa·s at 25° C.;
Adhesion package component 3 was a mixture comprising 50 wt. % Zirconium acetylacetonate in Polymer 2; and
The heat stabilization additive was 2-Hydroxy-N-1H-1,2,4-triazol-3-ylbenzamide.

### Preparation Process

As a first step an in-situ treated fumed silica masterbatch was prepared in a Kneader mixer by mixing the ingredients depicted in Table 1 and the stripping off residual water and treatment agents. Each part A and part B composition was then prepared using the components identified in Table 1 wherein the additional ingredients were introduced into the silicone rubber base of the treated filler in Polymer 1. The respective part A composition and part B composition were then mixed together and the resulting composition was either coated onto a one-piece woven airbag or was prepared for the physical property testing described below.

### Method for Measuring Mechanical Properties of Silicone Rubber

The physical properties of the comparative example and the example and corresponding cured samples were prepared and analysed with the results being depicted in Table 2 below.

For this analysis in each case, a 2 mm-thick cured silicone rubber specimen was obtained by subjecting the liquid curable silicone rubber composition to press curing for 10 min at 120° C. under a pressure of 30 tons. Hardness of the silicone rubber was measured by Shore A durometer in accordance with ASTM D 2240. Tensile strength, elongation at break and modulus results of the dumbbell-like specimen (no. 7) were measured in accordance with Japanese Industrial Standard JIS K 6251 using an MTS™ Criterion Model C41 commercially available from MTS Systems, equipped with 500 N load cell, and a nominal strain and elongation measured by crosshead distance referenced to an initial gauge length of 40 mm.

TABLE 2a
Physical Property Results

| Tested Property | C. 1 | Ex. 1 | Ex. 2 |
|---|---|---|---|
| Viscosity (at 10 s⁻¹) (Pa · s) | 90 | 105 | 85 |
| Shore A hardness | 18 | 6 | 5 |
| Tensile strength (MPa) | 4.6 | 5.3 | 5.9 |
| Elongation at break (%) | 730 | 1500 | 1590 |
| 500% Modulus (MPa) | 2.6 | 0.9 | 0.8 |

Loss tangent (tan δ) values were then analysed for each example and a coating composition of each example and comparative example were coated on a one-piece woven airbag in an amount resulting in a mean dry coat weight as hereinbefore described and analysed for the properties to hold inner pressure.

Method for Measuring loss tangent (tan δ) value The Part A and part B compositions were mixed in a 1:1 weight ratio in a speed mixer. Material was loaded to an Anton Paar MCR-301 rheometer equipped with 25 mm aluminum parallel plates. The temperature was increased from 23° C. to 150° C. using a Peltier heating device (ramp rate of 5° C. per minute), under constant normal force, constant oscillatory strain of 0.1% and constant angular frequency of 1 rad/s. The temperature was then held for 20 min to cure the composition. Subsequently, the temperature was reduced to 23° C. and held for a further 20 min. A frequency sweep step (0.1% oscillatory strain and 1 rad/s angular frequency) then measured moduli and tan delta as a function of angular frequency from (0.01 rad/s to 500 rad/s).

### Properties to Hold Inner Pressure

The Part A and part B compositions were mixed in a 1:1 weight ratio in a speed mixer and the C. 1, Ex. 1 and Ex. 2 final compositions were each coated onto identical one-piece woven airbags made from PET (polyethylene terephthalate woven fabric) by knife coating. The coated fabrics were then cured at 196° C. for 1 min.

The airbag was then tested using a cold gas inflation system commercially available from Microsys Technologies Inc. which is capable of holding in reserve a predetermined volume of gas or blend of gases to which an airbag is fixed. Upon test initiation a predetermined pressure is released from a holding reservoir into the bag. The inner space of the obtained coated hollow woven fabric was inflated by blowing compressed gas under a pressure of 165 kPa through a gas inlet port into the inner space to adjust the inner pressure to 70 kPa. The highest-pressure response measured after the pressure release is considered the ‘peak’ pressure that is achieved in the airbag. The difference in pressure observed from test initiation (P_{Osec}) to a target test duration 6 seconds (P_{6 sec}) and the resulting pressure retention was measured. The results are tabulated in Table 2b.

TABLE 2b
Loss tangent (tan δ) value and Properties to Hold Inner Pressure

| Tested Property | C. 1 | Ex. 1 | Ex. 2 |
|---|---|---|---|
| Loss tangent (tan δ) value (at 500 rad/s) | 0.15 | 0.2 | 0.2 |
| Average mean dry coat weight (g/m²) | 59 | 61 | 61 |
| Inner pressure-holding properties, % retained at 6 | 38 | 62 | 67 |
| sec | | | |

It can be seen that there is a significantly better loss tangent (tan δ) value from the example herein.

1. A one-piece woven airbag comprising a coating having a mean dry coat weight of from 45 to 62 g/m² determined in accordance with ISO 3801, wherein the coating is cured elastomeric product of a hydrosilylation curable silicone coating composition, the composition comprising:
a) an organopolysiloxane polymer having a viscosity of from 100 to 200,000 mPa·s at 25° C., and at least two unsaturated groups per molecule, where the unsaturated groups are selected from alkenyl or alkynyl groups;
b) reinforcing filler(s) comprising fumed silica and/or precipitated silica;
c) an organosilicon compound having at least two, optionally at least three, Si—H groups per molecule;
d) a hydrosilylation cure catalyst;
e) one or more substantially non-functional organosilicon compounds selected from;
(i) silicone resins selected from T silicone resins (silsesquioxanes), DT silicone resins, MQ silicone resins, MDT silicone resins, MTQ silicone resins, QDT silicone resins, or mixtures thereof, and/or
(ii) a trialkyl terminated polydiorganosiloxane; and
f) an adhesion promoter selected from one or more monoacrylates, diacrylates or methacrylates; epoxy-containing alkoxysilanes, alkoxysilane containing methacrylic groups or acrylic groups and a mixture and/or reaction product of;
i) one or more alkoxysilanes having an epoxy group in the molecule;
ii) a linear organopolysiloxane oligomer containing at least one alkenyl group and at least one hydroxy or alkoxy group per molecule; and
iii) an organometallic condensation reaction catalyst comprising organoaluminum or organozirconium compounds; or a mixture thereof; and
wherein the coating has a loss tangent (tan δ) value of at least 0.175 at an angular frequency of 500 rad/s, where tan δ=G″/G′=dynamic loss modulus/dynamic storage modulus and is determined by the rheological test method disclosed in the description.

2. The one-piece woven airbag in accordance with claim 1, wherein the coating has a mean dry coat weight of from 50 to 62 g/m² determined in accordance with ISO 3801.

3. The one-piece woven airbag in accordance with claim 1, wherein the one-piece woven airbag has greater than 60% inner pressure-holding properties retained after 6 seconds from deployment, determined by the test method disclosed in the description.

4. The one-piece woven airbag in accordance with claim 1, wherein component e) is a non-functional silicone resin selected from silsesquioxanes or MQ silicone resins.

5. The one-piece woven airbag in accordance with claim 1, wherein component e) comprises component e) (i), which is an MQ silicone resin having the formula:
(R⁴₃SiO_{1/2})ᵤ(SiO_{4/2}),
wherein R⁴ is a C₁ to C₁₀ hydrocarbon group free of aliphatic unsaturation, u is from 0.3 to 0.6, v is from 0.4 to 0.7, and the value of (u+v) is 1.0.

6. The one-piece woven airbag in accordance with claim 1, wherein the one-piece woven airbag is a curtain airbag.

7. The one-piece woven airbag in accordance with claim 1, wherein component e) comprises component e) (i), which is free of alkenyl and/or alkynyl groups and Si—H bonds.

8. A method of preparing a coated one-piece woven airbag by:
I) mixing components of a hydrosilylation curable silicone coating composition, the composition comprising:
a) an organopolysiloxane polymer having a viscosity of from 100 to 200,000 mPa·s at 25° C., and at least two unsaturated groups per molecule, where the unsaturated groups are selected from alkenyl or alkynyl groups;
b) reinforcing filler(s) comprising fumed silica and/or precipitated silica;
c) an organosilicon compound having at least two, optionally at least three, Si—H groups per molecule;
d) a hydrosilylation cure catalyst;
e) one or more substantially non-functional organosilicon compounds selected from;
(i) silicone resins selected from T silicone resins (silsesquioxanes), DT silicone resins, MQ silicone resins, MDT silicone resins, MTQ silicone resins, QDT silicone resins, or mixtures thereof, and/or
(ii) a trialkyl terminated polydiorganosiloxane; and
f) an adhesion promoter selected from one or more monoacrylates, diacrylates or methacrylates; epoxy-containing alkoxysilanes, alkoxysilane containing methacrylic groups or acrylic groups and a mixture and/or reaction product of:
i) one or more alkoxysilanes having an epoxy group in the molecule;
ii) a linear organopolysiloxane oligomer containing at least one alkenyl group and at least one hydroxy or alkoxy group per molecule; and
iii) an organometallic condensation reaction catalyst comprising organoaluminum or organozirconium compounds; or a mixture thereof; and
II) coating the one-piece woven airbag such that upon cure, the one-piece woven airbag comprises a coating having a mean dry coat weight of from 45 to 62 g/m² determined in accordance with ISO 3801, and wherein the coating has a loss tangent (tan δ) value of at least 0.175 at an angular frequency of 500 rad/s, where tan δ=G″/G′=dynamic loss modulus/dynamic storage modulus and is determined by the rheological test method disclosed in the description.

9. The method of preparing a coated one-piece woven airbag in accordance with claim 8, wherein component e) is a non-functional silicone resin selected from silsesquioxanes or MQ silicone resins.

10. The method of preparing a coated one-piece woven airbag in accordance with claim 8, wherein component e) comprises component e) (i), which is an MQ silicone resin having the formula:
(R⁴₃SiO_{1/2})ᵤ(SiO_{4/2}),
wherein R⁴ is a C₁ to C₁₀ hydrocarbon group free of aliphatic unsaturation, u is from 0.3 to 0.6, v is from 0.4 to 0.7, and the value of (u+v) is 1.0.

11. The method of preparing a coated one-piece woven airbag in accordance with claim 8, wherein component e) comprises component e) (i), which is free of alkenyl and/or alkynyl groups and Si—H bonds.

12. The method of preparing a coated one-piece woven airbag in accordance with claim 8, wherein component f) is present in the composition in an amount of from 0.1 to 6 wt. % of the composition.

13. The method of preparing a coated one-piece woven airbag in accordance with claim 8, wherein the one-piece woven airbag is coated with the composition by a least one of spraying, gravure coating, bar coating, coating by knife-over-roller, coating by knife-over-air, padding, dipping, and screen-printing.

14. The method of preparing a coated one-piece woven airbag in accordance with claim 8, wherein the coating has a mean dry coat weight of from 50 to 62 g/m² determined in accordance with ISO 3801.

15. The method of preparing a coated one-piece woven airbag in accordance with claim 8, wherein the one-piece woven airbag has greater than 60% inner pressure-holding properties retained after 6 seconds from deployment, determined by the test method disclosed in the description.

16. The one-piece woven airbag in accordance with claim 1, wherein component f) is present in the composition in an amount of from 0.1 to 6 wt. % of the composition.
